(19) United States
(12) Patent Application Publication
(10) Pub. No.: US 2010/0197786 A1
(43) Pub. Date: Aug. 5, 2010

(54) Insect-repellent formulations

(76) Inventor: Hanan Elraz, Kiryat Biyalik (IL)

Correspondence Address: DR. D. GRAESER LTD., 9003 FLORIN WAY, UPPER MARLBORO, MD, 20772, US

(21) Appl. No.: 12/589,519

(22) Filed: Nov. 27, 2008

(51) Int. Cl. A01N 37/02; A01P 17/00

(52) U.S. Cl. 514/557

(57) ABSTRACT

An insect repellent aqueous formulation comprising a combination of at least two essential oils, citrus peel tincture, and vinegar.

### FIELD OF THE INVENTION

The invention generally relates to homeopathy, and more specifically to an all-natural insect repellent.

### LIST OF PRIOR ART

The following is a list of references which are considered to be pertinent for describing the background and state of the art in the field of the invention. Acknowledgment of these references herein will be made by indicating the number from their list below within parentheses.
(1) Barnard, D. R. and R.-D. Xue, Laboratory evaluation of mosquito repellents against Aedes albopictus, Culex nigripalpus, and Ochlerotatus triseriatus (Diptera: Culicidae), J. Med. Entomol. 41(4), 726-30 (2004).
(2) Fradin, M. S, and J. F. Day, Comparative efficacy of insect repellents against mosquito bites, N. Engl. J. Med. 347(1), 13-18 (2002).
(3) Fried et al., U.S. Pat. No. 7,201,926.
(4) Meyhoefer, U.S. Patent Appl. Publ. No. 2006/0057174 A1.
(5) Bassett, U.S. Pat. No. 5,711,953.
(6) “West Nile Virus (WNV)”, Dept. of Health and Human Services, Centers for Disease Control and Prevention, Apr. 18, 2006, available at http://www.cdc.gov/ncidod/dvbid/westnile/resources/uprepinfo.pdf.
(7) “Protection against mosquitoes and other arthropods”, Travelers'Health: Yellow Book: Health Information for International Travel, 2005-2006, Dept. of Health and Human Services, Centers for Disease Control and Prevention, available at http://www2.ncid.cdc.gov/travel/yb/utils/ybGet.asp?section=recs&obj=bugs.htm.
   Each of the above-listed references is hereby incorporated by reference in its entirety, except where its terminology or description may be inconsistent with terminology or description used herein, in which case the present terminology or description supersedes the disclosure of such reference(s) with respect to such specific terminology or description.

### BACKGROUND OF THE INVENTION

Scientists have classified over 1 million species of insects on the earth. Some of these species are responsible for carrying and transmitting diseases to other animals, such as humans.

Some of the best known insect carriers of disease belong to the family Culicidae (mosquitoes). Public concern over the spread of disease by mosquitoes has existed at least since 1898, when Sir Ronald Ross showed that malaria was spread by these insects, but concern has heightened at various times in our recent history, such as in the last decade in connection with the rise of the West Nile virus.

In order to reduce the risks of contracting diseases carried by mosquitoes and other arthropods, public health authorities such as the U.S. Centers for Disease Control and Prevention (CDC) often recommend one or a combination of techniques such as avoidance, use of physical or chemical barriers such as nets or airborne aromatics, treatment of fabrics, and use of insect repellents typically applied to the skin.

The best known and most commonly used insect repellent is N,N-diethyl-3-methylbenzamide or N,N-diethyl-m-toluamide (DEET). Although DEET-containing repellents are considered to be effective in repelling insects such as mosquitoes, with the protective time for the wearer generally directly correlating to the concentration of DEET in the formulations, concerns with the compound's harmful ecological and health effects continue.

Some alternative insect repelling compounds are on the market, but such repellents are often weaker and less effective than DEET in terms of hours of protection. Although citronella oil is a well-known and widely used alternative insect repellent, one study found that 10% citronella oil (Natrapel™) repelled three species of mosquitoes for as little as half an hour and for an average of 2.3 hours between the species tested, as compared with 7% DEET (Skinsations™) and 15% DEET (Off!®) repellents, which were effective for as little as 4.7 hours and an average of 4.8 hours between the species, and for as little as 7.0 hours and an average of 7.2 hours, respectively.(Reference 1) Other all-natural formulations (Neem Aura™, GonE!™, SunSwat™, Bygone™, Bite Blocker™, MosquitoSafe™, Repel™; see reference (reference 1) for ingredients of each) containing certain essential oils tested in the same study were found to be effective for less than an average of 3 hours across the board, except for a formulation containing 26% oil of lemon eucalyptus (Repel™), which repelled the three species of mosquitoes tested for an average of 7.2 hours. Another study tested four commercially available insect repellent products containing DEET as the active ingredient in concentrations of 4.75% (Off!® Skintastic for Kids™) to 23.8% (Off!® Deep Woods™). The products ranged from a mean of 88.4 minutes of protection for the low-concentration product to a mean of 301.5 minutes of protection for the highest-concentration product.(Reference 2)

The same study also tested several other products containing citronella and other oils. Products containing 5% (Buzz Away™) and 10% citronella (Natrapel™) showed means of 13.5 minutes and 19.7 minutes protection, respectively.(Reference 2) A formulation of 10% citronella and 2% peppermint oil showed a mean protection time of 14 minutes.(Reference 2) A formulation including 12% citronella oil, 2.5% peppermint oil, 2% cedar oil, 1% lemongrass oil, and 0.05% geranium oil (Herbal Armor™) showed similar results to the 10% citronella product (mean of 18.9 minutes protection).(Reference 2) A soybean oil (2%)-based product (Bite Blocker for Kids™) showed a mean of 94.6 minutes of protection.(Reference 2) The authors also performed preliminary studies on Repel™ Lemon Eucalyptus Insect Repellent, and found a mean protection time of 120 minutes

According to the CDC, products registered with the U.S. Environmental Protection Agency (EPA) for use as effective insect repellents which contain DEET and Picaridin (KBR 3023) as active ingredients typically provide longer-lasting protection than other repellents, as shown in references (1) and (2), above.(Reference 6)'(Reference 7) However, DEET is toxic when ingested and may cause skin irritation in sensitive persons,(Reference 7) and concerns with its safety persist. Oil of lemon eucalyptus (p-menthane 3,8-diole (PMD)) is also registered with the EPA, and shows effectiveness similar to low concentrations of DEET, according to the same studies.(Reference 6),(Reference 7)

Most insect repellents registered with the EPA have warnings not to use them near food or in waters where fish live, or that they should not be applied to children.(Reference 3) There is, therefore, a growing awareness of the market for alternative, all-natural insect repellents which are safer for human and animal use than the above non-natural repellents. The U.S. Food and Drug Administration (FDA) classifies certain compounds, including certain essential oils showing some insect repelling activity, as “GRAS”, or “Generally Regarded As Safe”, compounds. These include citronella oil and D-limonene, a member of the terpene class of compounds.(Reference 3)

Citronella oil and eucalyptus oil (also called oil of lemon eucalyptus; active ingredient: p-Menthane 3,8-diole) are commonly used natural insect repellent compounds, and are also registered for use as such by the U.S. EPA.(Reference 7) Various other essential oils have also been purported to have insect repelling properties, although generally with very limited times of effectiveness, usually being less than one hour. One study concluded that the “inclusion of essential oils in repellent products does not ensure activity against mosquitoes. The basis for incorporating other plant essential oils or extracts in mosquito repellent products is problematic.”(Reference 1) Another study found that “currently available non-DEET repellents do not provide protection for durations similar to those of DEET-based repellents and cannot be relied on to provide prolonged protection in environments where mosquito-borne diseases are a substantial threat.”(Reference 2) Their results showed that, aside from a soybean oil product, “[a]ll other botanical repellents . . . tested . . . , regardless of their active ingredients and formulations, gave very short-lived protection, ranging from a mean of about 3 to 20 minutes.”(Reference 2)

U.S. Pat. No. 7,201,926 discloses an insect repellent composition requiring citronella oil, D-limonene (1-methyl-4-(1-methylethenyl)cyclohexane), two or more synergists (e.g., N-amyl alcohol, aldehyde C-14, aldehyde C-18), and three or more essential oils, preferably being geranium oil, rosemary oil, and peppermint oil.(Reference 3)

U.S. Patent Application Publication No. 2006/0057174 discloses an insect repellent solution comprising 0.3-0.7% rosemary oil, 0.05-0.3% citronella oil, and 0.1-0.3% table salt.(Reference 4) Optionally, 0.07-0.7% of mint, lemon grass, thyme, and/or wintergreen oils, as well as 7-12% vinegar, may be added to the formulation.(Reference 4) The reference does not disclose data as to length of time of protection from mosquito or other insect bites.(Reference 4)

U.S. Pat. No. 5,711,953 discloses an insect repellent comprising 90-95% carrier (e.g., vinegar), 0.5-5% garlic extract, 0.5-5% hot pepper extract, and 0.5% surfactant.(Reference 5)

### SUMMARY OF THE INVENTION

The present invention provides an insect repellent aqueous formulation comprising the following ingredients: a combination of at least two essential oils, citrus peel tincture, and vinegar.

The novel combination of ingredients in the insect repellent formulation of the invention creates a substantially enhanced effect compared to that obtained by using each of the ingredients separately.

The formulation of the invention uniquely combines active ingredients possessing repelling effects on insects (e.g. essential oils, vinegar) with an alcoholic extract of citrus peel which allows effective dispersion of the formulation in the air surrounding the person using the formulation, as well as stabilization.

In a preferred embodiment the formulation further comprises an emulsifier.

In one embodiment the essential oils are selected from the group consisting of lemongrass oil, citronella oil, eucalyptus oil, tea tree oil, lavender oil, geranium oil, clove oil, Cajeput oil and Lemon balm oil. The concentration (volume/volume) of each of the essential oils in the formulation ranges between about 0.1% and about 3%, preferably between about 0.5% and about 2%.

In one embodiment, the citrus tincture is mandarin tincture. The concentration (volume/volume) of the citrus tincture in the formulation ranges between about 0.1% and about 1%, preferably about 0.5%.

In one embodiment the vinegar is apple vinegar in a concentration ranging between 1%-10%, preferably between 4% and 6%, and more preferably about 5%. In one embodiment, the emulsifier is Tween 20. The concentration (volume/volume) of the emulsifier in the formulation ranges between about 0.1% and about 1%, preferably about 0.5%.

In a preferred embodiment the insect repellent formulation of the invention comprises a combination of lemongrass oil, citronella oil, tea tree oil, lavender oil, mandarin peel tincture, apple vinegar and Tween 20.

In one embodiment, the formulation of the invention further comprises additional ingredients having insect repelling activity.

By another aspect, the present invention provides an applicator suitable for administration of the formulation of the invention.

In one embodiment, the applicator is selected from the group consisting of a pump dispenser suitable for spraying the formulation onto the skin, an applicator stick, or napkins soaked with the formulation suitable for rubbing the formulation on the skin and a sticker soaked with the formulation suitable for attachment onto the skin.

In another aspect, the present invention provides a method for protecting individuals from being stung by insects comprising applying the formulation of the invention using an applicator as described above.

In another aspect, the present invention provides a method of preparing an insect repellent aqueous formulation comprising:

a. Mixing a combination of essential oils with an emulsifier and citrus tincture;
b. Adding to the mixture water at a temperature of about 40° C. and vinegar, wherein the final concentration (v/v) of water is 90% and the final concentration of vinegar (v/v) is 5%;
c. Mixing for about 2 hours at ambient temperatures using a mechanical stirrer; and
d. Allowing the mixture to rest prior to administration; the resting period may be for about 24 to 72 hours, preferably for about 48 hours.

### DETAILED DESCRIPTION OF NON-LIMITING EMBODIMENTS

The present invention provides a novel all-natural insect repellent formulation which is safe for human and animal use and which is environmentally friendly. The formulation of the invention is a combination of two or more active ingredients, which shows a synergistic effect in terms of length of time of effectiveness in repelling insects.

Referring to insect repellent aqueous formulations disclosed below, as well as to methods for preparation of insect repellent aqueous formulations, it should be noted that such insect repellent aqueous formulations and such methods are also effective in repelling different types of insects, such as (though not limited to) the types of insects enlisted in appendix A.

Additionally, those formulations and methods are further effective for: agricultural uses such as disinfestations of maggots (e.g. of mosquitoes in water bodies), general disinfestations of varmints in agricultural crop and in horticultural crop, etc.

Appendix B includes additional information as well as experimental results, which are incorporated herein.

The present invention is based on the surprising finding that a mixture of an alcoholic extract of citrus peels (tincture) with a combination of plant essential oils in an aqueous solution containing vinegar, provided a synergistic insect repelling effect, exhibited by a prolonged duration of protection from insect bites and stings than that obtain by using each of the ingredients separately.

The insect repellent formulation of the invention may also include an emulsifier and preferably comprises citrus tincture, lemongrass oil, citronella oil, tea tree oil, lavender oil, apple vinegar, and Tween −20. This preferred formulation provides effective repellent activity against insects for a long period of time (i.e. at least about 6-8 hours).

As used herein, an “insect repellent formulation” is a composition which repels insects. Repellence may be determined by either the inhibition of insect approach, landing on a target or stinging.

As used herein, the term “synergistic effect” means a time of insect repellence achieved with a combination of two or more active ingredients which is longer than the greatest time of repellence achieved for any one of the ingredients when applied to a subject's skin as the sole active ingredient.

As used herein, an “essential oil” is any concentrated, hydrophobic liquid containing volatile aroma compounds from plants. Essential oils in the context of the invention may include, without being limited thereto, an essential oil selected from lemongrass oil, citronella oil, eucalyptus oil, tea tree oil, lavender oil, spearmint oil, geranium oil, rosemary oil, Lemon balm oil, peppermint oil, pine needle oil, lavandin oil, cinnamon oil, clove oil, thyme oil, wintergreen oil, cedar oil, lemon oil, grapefruit oil, mandarin oil, tangerine oil, orange oil, citrus oil, lime oil, coriander oil, pomegranate oil, soybean oil, cajeput oil, walnut oil, peanut oil, corn oil, canola oil, sunflower oil, sesame oil, linseed oil, safflower oil, olive oil, etc.

As used herein, “citrus tincture” is an alcoholic extract of citrus peel. As used herein, Citrus refers to a genus of fruit comprising, but not limited to, orange, bergamot, grapefruit, lemon, lime and mandarin.

“Vinegar” in the context of the invention refers to a sour, aqueous liquid, generally containing about 4%-8% acetic acid, obtained by the acetic fermentation of dilute, aqueous alcohol solutions, e.g. by bacterial fermentation of wine, apple cider or fruit juice.

As used herein, the term “active ingredient” means a compound which possesses an insect repelling activity when applied to a subject's skin, e.g. turpentine, pennyroyal.

As used herein, the term “emulsifier” (also known as an “emulgent”) means a substance which stabilizes an emulsion, frequently a surfactant. Non limiting examples include Tween and paraffin oil.

As used herein, the term “aqueous formulation” means a water-based composition, wherein the major component of the composition, by volume, is water.

### DESCRIPTION OF NON-LIMITING ILLUSTRATIVE EXAMPLES

### Materials

The following plant-based materials were each purchased from Perry & Lowe, Hamburg, Germany, and used without dilution: lemongrass oil, tea tree oil, citronella oil, lavender oil. All-natural 5% apple vinegar (95% water) was purchased in Israel at Carmel Mizrachi. Mandarin peel alcoholic extract (tincture) was purchased in Israel.

### Formulations

Various formulations comprising each of the above natural substances or their mixtures were assayed for their ability and efficiency in repelling insects.

### I. Single Active Ingredients

Each of the following ingredients was tested as a single component: lemongrass oil, citronella oil, eucalyptus oil, tea tree oil, lavender oil, geranium oil, clove oil, Cajeput oil, Lemon balm and 5% apple vinegar. Each of the listed ingredients was spread as such over an exposed body surface. In addition, preparations containing one essential oil and citrus tincture were also prepared, e.g. lemongrass and mandarin tincture.

### II. Single Essential Oil in a Formulation

The formulation was prepared by mixing the active ingredients with a carrier according to the following procedure:

An essential oil (e.g. lemongrass oil) was mixed briefly using a mechanical stirrer with mandarin tincture, and Tween 20. This was followed by the addition of distilled water heated to 40° C. and apple cider vinegar, and the mixture was further stirred for about two hours. The resulting formulation obtained was an emulsion comprising 5% (v/v) cider vinegar, and 90% water.

### III. Combined Essential Oils

A combination of the following ingredients was tested. Geranium oil, clove oil, Cajeput oil, and Lemon balm oil were mixed and spread over an exposed body surface.

### IV. Combined Essential Oils in a Formulation

Multi-component formulations were prepared by first forming a concentrate comprising a combination of essential oils, mandarin tincture and Tween 20 (“Stock solution”). The concentrate was then mixed for 2 hours, using a mechanical stirrer, with distilled water (heated to 40° C.) and natural apple vinegar, to obtain the following v/v ratios in the total diluted formulation:

Stock solution—5%;
Apple vinegar—5%;

### Water—90%

One examined stock solution (Formulation I) included the following ingredients: tea tree oil, citronella oil, lemongrass oil, lavender oil, mandarin peel tincture, and Tween 20 as an emulsifier. The total concentrations of all of the ingredients in the combined, multi-component repellent formulation are provided in Table 1.

TABLE 1
Multi-component repellent formulation I

| Ingredient | Amount v/v |
|---|---|
| Tea tree oil | 1% |
| Lemongrass oil | 0.5% |
| Citronella oil | 2% |
| Lavender oil | 0.5% |
| Mandarin peel tincture | 0.5% |
| Apple vinegar | 5% |
| Tween 20 | 0.5% |
| Water | 90% |
| Total | 100% |

Another examined stock solution (Formulation II) included the following ingredients: Geranium oil, clove oil, Cajeput oil, Lemon balm oil, mandarin peel tincture, and Tween 20. The total concentrations of all of the ingredients in the combined, multi-component repellent formulation are provided in Table 1.

### Methods

The single or combined formulations were topically applied to exposed (bare) areas of the skin.

Applications of the various formulations was performed using one of the following techniques:

1. introducing the formulations into a pump-dispenser (50 ml) and spraying the formulation onto the skin;
2. attaching a sticker soaked with the formulation onto the skin;
3. saturating fabric napkins with the formulation (by soaking the fabric napkins in the formulation for about 24 hours) and rubbing the napkins on the skin.

### Results

Field tests were conducted at three separate locations in Israel having different climates: (1) Neot HaKikar, in the eastern Negev near the Dead Sea; (2) the fish ponds of Kibbutz Maayan Tzvi, on the northern coast of the Mediterranean north of Tel Aviv and south of Haifa; and (3) the orchards of Kibbutz Kabri, on the northern coast of the Mediterranean near the Lebanon border.

Typical species of mosquitoes present at the above three locations were species of the genera Anopheles (e.g., Anopheles gambiae), Culex (e.g., Culex pipiens), and Aedes (e.g., Aedes aegypti). Species belonging to these genera of mosquitoes are known to carry viral and protozoan vectors causing West Nile virus, malaria, Leishmaniasis (Leishmania major, Leishmania tropica, and Leishmania infantum), and Dengue fever. Mosquitoes were present in large numbers at each location. Field tests were conducted in the presence of an entomologist.

Six volunteers (4 men and 2 women) participated in the field experiments. Two tests were performed at each location on consecutive days. On Day 1, the volunteers were exposed without applying any insect repelling preparations and were bitten multiple times on bare arms and legs by mosquitoes within 5 minutes after being in the field.

On the second day at the same locations, each volunteer applied a tested formulation on different locations of the skin, using the sticker, spray or wipes.

The time of repelling mosquitoes (“repellency time”) for each of the formulations tested was calculated for each volunteer participant by noting the amount of time elapsed from first exposure to mosquitoes to first mosquito bite received, and the times were averaged for each formulation tested. The repellency times for each single active ingredient formulation tested applied with a stick are indicated in Table 2A.

TABLE 2A
Average repellency times for each single active ingredient.

| Formulation | Time (min.) |
|---|---|
| Tea tree oil | 40 |
| Lemongrass oil | 30 |
| Citronella oil | 60 |
| Lavender oil | 30 |
| Eucalyptus oil | 30 |
| Geranium oil | 40 |
| clove oil | 30 |
| Cajeput oil | 40 |
| Lemon balm oil | 30 |
| Apple vinegar | 90 |

The repellency times for each combined ingredient formulation tested, applied in the form of each of the sticker, wipes and spray, are indicated in Table 2B. Stickers, wipes and spray all showed approximately the same length of time of repellency. Results were thus independent of formulation type/method of application.

TABLE 2B
Average repellency times for combined formulations.

| | Time | Repelling |
|---|---|---|
| Formulation | (min.) | Quality¹ |
| lemongrass oil and mandarin peel tincture | 45 | N/A |
| lemongrass oil, mandarin peel tincture and | 135 | 8 |
| apple vinegar | | |
| geranium oil, clove oil, cajeput oil, and Lemon | 150 | N/A |
| balm oil | | |
| geranium oil, clove oil, cajeput oil, Lemon balm | 315 | 9 |
| oil, mandarin tincture and apple vinegar | | |
| Tea tree, citronella, lemongrass, and lavender | 360-480 | 10 |
| oils, mandarin peel tincture, and apple vinegar | | |

¹The repelling quality is measured at a scale of 1-10, where 1 is hardly any protection and 10 represents total protection.

### Additional Test Results

Appendix A and appendix B provide additional test results of a formulation that included Tea tree, citronella, lemongrass, and lavender oils, mandarin peel tincture, and apple vinegar was further tested on several volunteers and on a water canal.

### APPENDIX A

### Results of a Test

### Methods

A formulation (Herein—the formulation) that included Tea tree, citronella, lemongrass, and lavender oils, mandarin peel tincture, and apple vinegar was further tested on several volunteers and on a water canal was tested.

Mosquito larvae were collected from different water sources in the Galilee and northern Israel and were placed in plastic soup bowls with the water of the origin. The bowls were placed on the bottom of a 70×70×70 cm outdoor cage. The cage had four wooden walls (bottom, ceiling, left and the back walls).

Other than the bottom, all wooden walls had a ventilation opening covered with a mosquito mesh. The cage had two glass walls (front and right hand) in addition to the wooden walls. The front glass wall had a 9 cm round opening protected by a mesh sleeve, The cage was positioned in anal day shaded location in Mitzpe Adi I the Galilee, Israel. Dry sugar, 10% sugar water and pitch slices were placed on the bottom of the cage as a nutrition source for the emerged adult mosquito.

On Sep. 2, 2007, 120 adult mosquitoes were observed in the cage. About 50% of the mosquitoes were Culex pipiens and another 50% were Culex univittatus, which are both common in Israel and may transfer the West Nile Virus. About 50% of the adults that were observed that day were females.

At 5:15 pm the formulation was spread on the left arm of 7 volunteers between the elbow and the hand. The right arm was left unattended.

Between 7:10 and 7:25 pm, each of the 7 volunteers introduced his/her right (unattended) arm into the cage for 30 seconds, and then his/her left arm for additional 30 seconds. The tester recorded the number of landing mosquito on each volunteer arm during that time (table no. 1). We preformed this inspection in a temperature of 30° C. and dusk illumination. We followed this procedure similarly twice more on 8:10 and 9:10 pm. The later inspections differed from the early one only by the source of illumination (artificial rather than sunlight). The temperatures on 8:10 and 9:10 pm were 30° C. and 29° C. accordingly (table 1).

### Results

The average numbers (±Standard Error) of landing mosquitoes on the unattended arms in 30 seconds were as follows:

During the first inspection (7:10-7:25 pm, two hours after the repellent was spread) 5.43 (S.E.=±0.97) mosquitoes.

During the second inspection (8:10-8:25 pm, three hours after the repellent was spread) 1 (S.E.=±0.65) mosquito.

During the third and last inspection (9:10-9:25 pm, four hours after the repellent was spread) 4 (S.E.=±1.13) mosquitoes.

During all three inspections (7:10-9:25 pm), no mosquito was landed on none of the treated arms (table no. 1).

### Conclusions

According to the results of the control (number of landing mosquitoes on the unattended arms) the formulation was examined with ready to bite mosquito females. The formulation showed high efficiency repelling mosquitoes for as long as four hours. No repellency reduction was observed during the last inspection, four hours after the repellent was spread on the arms, as the formulation remained 100% repellent. Accordingly, it is highly reasonable that the formulation repel mosquitoes for a longer period than 4 hours. The inspected mosquito species (Culex pipiens and Culex univittatus) are of the most common human biters mosquitoes in Israel and may transfer pathogens like West Nile Virus. The importance of this study on these species is high due to their high levels of distribution and their nuisance and public health hazard effects.

TABLE NUMBER 1
The experimental report of the formulation.

| Time | | | | | | # mosquito landing | |
|---|---|---|---|---|---|---|---|
| since | | | # | | | in ½ a minute | |
| B.O | Time of | Temp | volun- | | | Untreated | Treated |
| spread | day | (° C.) | teer | Age | Sex | arm | arm |
| 2 hours | 7:10 pm | 30° | 1 | 39 | M | 8 | 0 |
| | | | 2 | 45 | M | 4 | 0 |
| | | | 3 | 45 | F | 8 | 0 |
| | | | 4 | 17 | M | 6 | 0 |
| | | | 5 | 17 | M | 4 | 0 |
| | | | 6 | 17 | M | 7 | 0 |
| | 7.25 pm | | 7 | 41 | M | 1 | 0 |
| 2 hours | | | Average | | | 5.43 | 0 |
| | | | S.E. | | | 0.97 | |
| 3 hours | 8.10 pm | 30° | 1 | 39 | M | 4 | 0 |
| | | | 2 | 45 | M | 0 | 0 |
| | | | 3 | 45 | F | 3 | 0 |
| | | | 4 | 17 | M | 0 | 0 |
| | | | 5 | 17 | M | 0 | 0 |
| | | | 6 | 17 | M | 0 | 0 |
| | | | 7 | 41 | M | 0 | 0 |
| 3 hours | | | Average | | | 1.00 | 0 |
| | | | S.E. | | | 065 | |
| 4 hours | 9.10 pm | 29° | 1 | 39 | M | 4 | 0 |
| | | | 2 | 45 | M | 1 | 0 |
| | | | 3 | 45 | F | 4 | 0 |
| | | | 4 | 17 | M | 2 | 0 |
| | | | 5 | 17 | M | 5 | 0 |
| | | | 6 | 17 | M | 10 | 0 |
| | | | 7 | 41 | M | 2 | 0 |

| | | |
|---|---|---|
| 4 hours | Average | 4.00 |
| | S.E | 1.13 |

The table demonstrates the repellent efficiency protecting the arms of 7 different volunteers from the contact of about 60 Culex pipiens and Culex univittatus mosquito females.

### APPENDIX B

### Results of Another Test

A formulation (Herein—the formulation) that included Tea tree, citronella, lemongrass, and lavender oils, mandarin peel tincture, and apple vinegar was further tested on several volunteers and on a water canal was tested.

### Methods

For the evaluation of the formulation a canal was treated. The canal is characterized by slow running water known as Canal 42. This canal's water contains many mosquito larvae and pupae (mostly Culex sp.). The canal is located between two councils, the town Qiriat-Bialik and the local councils Matte-Asher. The water in the canal is running from south to north toward Na'aman stream. The site had no insect control activity for a long period of time and was proved by both councils. The tested canal area was 72 m long, 4.6 m wide and water depth was approximately 25 cm.

Monitoring (manual and visual inspection recorded on video) was preformed from Sep. 18 to Oct. 3, 2007 as follows:

September 18—Survey and video recording of the canal for pre-treatment conditions.

September 19—Survey and video recording of the canal shortly before applying the treatment. Spraying the water surface with 15 liter of 5% liquid agent (covering 4.6 xn m).

September 20—Recording the mosquito larva and pupae level 1 day after treatment.

September 24—Recording the mosquito larva level 5 days after treatment.

October 3—Recording the mosquito larva level 15 days after treatment.

Each recording activity included total fauna and flora evaluation.

In addition to the aforementioned study, an indoor study examined the mortality rate of Culex larvae collected from Canal 42. Additional small study tested the effect of The formulation on the mosquito (Aedes mariae) larvae and pupae in a sea shore rock pool.

### Results and Discussion

The formulation (5% concentration) affected mosquitoes negatively soon after it was sprayed. Within less than half an hour after a few drops of The formulation were add into two test tubes with mosquitoes (Culex sp.) all larvae died. In Canal 42, about 26 to 17 mosquito larvae were observed in 70 ml water samples. Mosquitoes' levels where examined in this canal about an hour after 15 liter of 5% the formulation were applied over area of nx4.6 m. With a resemblance to the indoor results, mosquitoes were found in the treated area in none of the samples. Furthermore, the effect of the formulation was not restricted to the treated area. Since the water in Canal 42 slowly runs northward, the sprayed mosquito control agent was drifted and had a complete negative effect on mosquitoes (100% mortality) at least 200 meters away from the sprayed area. About 400 meters away downstream from the sprayed area no effect of

The formulation was observed. After treating Canal 42 with the formulation, and at the same time when no larvae were found in the treated area, many mosquito larvae were observed in non-treated areas and areas with no drifted control agent (table no. 1). These results suggest that the absence of mosquitoes is a result of the treatment with the formulation and of a quick and effective negative response of the mosquitoes to the formulation.

The effect of the formulation was clearly noticeable long after it was sprayed. Fifteen days after spraying neither mosquito larvae nor pupae was observed in the sprayed area (except for the 5 most southern meters). This result was achieved in spite of the slow running water in the sprayed canal, and nevertheless the formulation effect was not drifted downstream. However, this south to north water flow explain the weakening effect of The formulation in the first most southern 5 meters that was observed 10 days after spraying.

| | Days after | Mosquitoes in the | Mosquitoes outside the |
|---|---|---|---|
| Date | spraying | sprayed area | sprayed area |
| Sep. 18 | −1 | 26 larvae per 70 ml | Larvae and pupae were |
| | | | observed in the water |
| Sep. 19 | 0 − an hour | 17 larvae per 70 ml | |
| Sep. 19 | 0 + an hour | 0 | |
| Sep. 20 | 1 | 0 | No larvae 200 m |
| | | | northward |
| Sep. 24 | 5 | 0 | Many larvae 450 m |
| | | | northward |
| Sep. 28 | 10 | 0 (except for the 5 most | Many larvae 400 m |
| | | southern meters) | northward |
| Oct. 3 | 15 | 0 | Many larvae south to |
| | | | the sprayed area |

The fauna and flora were observed and found in a similar condition before and after spraying. Both before and after spraying Spur-winged Plover (Vanellus spinosus) and Great White Egret (Egretta alba) were observed in and next to the water. Adult dragonflies and damselflies were flying above the water and rested 0 the vegetation before and after spraying. The prayed area included papyrus (Cyperus sp.) plants. After spraying with the formulation no change in plant condition (e.g. turning yellow, leaning down) was observed. After spraying, at the same time when mosquito did not recolonized yet in the sprayed area, two fly species were observed on (a swarm of Ephydridae) and in (most likely a species of the Stratiomyidae) the water. These observations imply that despite the severe damage that the formulation causing mosquito populations, the aforementioned species are indifferent to this control agent, and that the formulation is probably a specific mosquito control agent. According to these observations, the formulation may be used in a vast variety of environments with little or no fear for environmental negative effects.

Summarizing some (though not all) significant aspect of the disclosed invention:

1. An insect repellent aqueous formulation including a combination of at least two essential oils, citrus peel tincture, and vinegar.
2. An insect repellent aqueous formulation such as in above item no. 1 further including an emulsifier.
3. An insect repellent aqueous formulation such as in above item nos. 1 or 2 wherein the essential oils are selected from the group consisting of lemongrass oil, citronella oil, eucalyptus oil, tea tree oil, lavender oil, geranium oil, clove oil, Cajeput oil and Lemon balm oil.
4. An insect repellent aqueous formulation such as in above item no. 3 wherein the volume/volume concentration of each of the essential oils in the formulation ranges between about 0.1% and about 3%.
5. An insect repellent aqueous formulation such as in above item no. 4 wherein the volume/volume concentration of each of the essential oils in the formulation ranges between about 0.5% and about 2%.
6. An insect repellent aqueous formulation according to any of the preceding items, wherein the citrus peel tincture is mandarin tincture.
7. An insect repellent aqueous formulation according to any of the preceding items, wherein the volume/volume concentration of the citrus tincture in the formulation ranges between about 0.1% and about 1%.
8. An insect repellent aqueous formulation such as in above item no. 7 wherein the volume/volume concentration of the citrus tincture in the formulation is about 0.5%.
9. An insect repellent aqueous formulation according to any of the preceding items, wherein the vinegar is apple vinegar.
10. An insect repellent aqueous formulation according to any of the preceding items, wherein the volume/volume concentration of the vinegar in the formulation ranges between about 1% and 10%.
11. An insect repellent aqueous formulation such as in above item no. 10 wherein the volume/volume concentration of the vinegar in the formulation ranges between about between 4% and 6%.
12. An insect repellent aqueous formulation such as in above item no. 11 wherein the volume/volume concentration of the vinegar in the formulation is about 5%.
13. An insect repellent aqueous formulation such as in above item no. 2 wherein the emulsifier is Tween 20 or Paraffin oil.
14. An insect repellent aqueous formulation such as in above item no. 13 wherein the concentration (volume/volume) of the emulsifier in the formulation ranges between about 0.1% and about 1%.
15. An insect repellent aqueous formulation such as in above item no. 14 wherein the concentration (volume/volume) of the emulsifier in the formulation ranges is about 0.5%.
16. An insect repellent aqueous formulation including lemongrass oil, citronella oil, tea tree oil, lavender oil, mandarin peel tincture, apple vinegar and Tween 20.
17. An insect repellent aqueous formulation according to any of the preceding items, further including additional ingredients having an insect repelling activity.
18. An applicator suitable for administration of an insect repellent aqueous formulation according to any of the preceding items.
19. An applicator such as in above item no. 18 selected from the group consisting of: a pump dispenser suitable for spraying said formulation onto an individual's skin, an applicator stick suitable for rubbing said formulation on an individual's skin, a napkin soaked with said formulation suitable for rubbing the formulation on an individual's skin and a sticker soaked with said formulation suitable for attachment onto an individual's skin.
20. A method for protecting individuals from being stung by insects including applying to an individual an insect repellent aqueous formulation according to any of the above numbered items 1-17.
21. A method of preparing an insect repellent aqueous formulation including:
a. Mixing a combination of essential oils with an emulsifier and citrus tincture;
b. Adding to the mixture obtained in (a) distilled water at a temperature of about 40° C. and vinegar, wherein the final volume/volume concentration of water is 90% and the final volume/volume concentration of vinegar is about 5%;
c. Mixing the solution obtained in (b) for about 2 hours at ambient temperatures using a mechanical stirrer; and
d. Allowing the mixed solution to rest prior to administration.

1-4. (canceled)

5. An insect repellent aqueous formulation comprising a combination of at least two essential oils, citrus peel tincture, and vinegar, adapted for application to an environmental location.

6. The formulation of claim 1 further comprising an emulsifier.

7. The formulation of claim 1 wherein the essential oils are selected from the group consisting of lemongrass oil, citronella oil, eucalyptus oil, tea tree oil, lavender oil, geranium oil, clove oil, Cajeput oil and Lemon balm oil.

8. The formulation of claim 7 wherein the volume/volume concentration of each of the essential oils in the formulation ranges between about 0.1% and about 3%.

9. The formulation of claim 8 wherein the volume/volume concentration of each of the essential oils in the formulation ranges between about 0.5% and about 2%.

10. The formulation of claim 9 wherein the citrus peel tincture is mandarin tincture.

11. The formulation of claim 10 wherein the volume/volume concentration of the citrus tincture in the formulation ranges between about 0.1% and about 1%.

12. The formulation of claim 11 wherein the volume/volume concentration of the citrus tincture in the formulation is about 0.5%.

13. The formulation of claim 12 wherein the vinegar is apple vinegar.

14. The formulation of claim 13 wherein the volume/volume concentration of the vinegar in the formulation ranges between about 1% and 10%.

15. The formulation of claim 14 wherein the volume/volume concentration of the vinegar in the formulation ranges between about between 4% and 6%.

16. The formulation of claim 6 wherein the emulsifier is Tween 20 or Paraffin oil.

17. The formulation of claim 16 wherein the concentration (volume/volume) of the emulsifier in the formulation ranges between about 0.1% and about 1%.

18. The formulation of claim 17 wherein the concentration (volume/volume) of the emulsifier in the formulation ranges is about 0.5%.

19. An insect repellent aqueous formulation comprising lemongrass oil, citronella oil, tea tree oil, lavender oil, mandarin peel tincture, apple vinegar and Tween, adapted for application to an environmental location.

20. The insect repellent aqueous formulation of claim 19, wherein said carrier provides the form of a solid, liquid, powder or foam.

21. The insect repellent of claim 20, wherein said carrier is suitable for distribution of the formulation through spraying, spreading, coating, dripping, dissolving or sprinkling.

22. A method of treating an outdoor location, comprising applying the insect repellent of claim 19 to an outdoor location, wherein said outdoor location includes one or more of agricultural fields, landscaped areas, other types of fields and grounds, and bodies of water.

23. The method of claim 22, further comprising performing insect control with said insect repellent.
